(19) United States
(12) Patent Application Publication
(10) Pub. No.: US 2011/0099339 A1
(43) Pub. Date: Apr. 28, 2011

(54) INFORMATION PROCESSING APPARATUS, METHOD FOR CONTROLLING INFORMATION PROCESSING APPARATUS AND STORAGE MEDIUM

(75) Inventor: Yuichi Hagiwara, Tokyo (JP)

(73) Assignee: CANON KABUSHIKI KAISHA, Tokyo (JP)

(21) Appl. No.: 12/874,969

(22) Filed: Sep. 2, 2010

(30) Foreign Application Priority Data
Oct. 28, 2009 (JP) 2009-248014

(51) Int. Cl. G06F 12/00; G06F 1/26

(52) U.S. Cl. 711/154; 713/300; 711/E12.001

(57) ABSTRACT

The information processing apparatus of the present invention comprises a control unit configured to control such that part of a storage region of the second storage unit is used as a virtual storage region for the first storage unit when the information processing apparatus is operating in the first mode, and part of a storage region of the third storage unit is used as the virtual storage region for the first storage unit when the information processing apparatus is operating in the second mode.

### BACKGROUND OF THE INVENTION

1. Field of the Invention

The present invention relates to an information processing apparatus, a method for controlling an information processing apparatus, and a storage medium.

2. Description of the Related Art

As environmental awareness has grown in recent years, there have been efforts to achieve power saving to the highest degree possible without impairing usability for users: when an information processing apparatus has not been used for a predetermined period of time, the information processing apparatus enters a low power consumption state in which power supply to some of the constituent elements of the information processing apparatus is stopped. For example, in the case of an image forming apparatus such as a copy machine, upon entering the low power consumption state, power supply to the printer unit and the scanner unit is stopped. Furthermore, in recent years, demand for power saving is increasing even for controllers that control an information processing apparatus. Among the controllers, the hard disk drive (hereinafter referred to as the “HDD”) in particular consumes a relatively large amount of power, and thus large effects can be obtained if the power supply to the HDD is stopped during the low power consumption state. In addition, it is generally known that the failure rate of the HDD rises as the operating time increases, and from such a point of view, it is desired to stop power supply to the HDD during the low power consumption state.

However, the HDD has a virtual storage function (swap function) for securing the capacity of real memory, and therefore if the HDD does not function, problems occur such as being unable to execute various application software, and being unable to respond when an interrupt request from outside requires the data stored in the HDD. For this reason, if power supply to the HDD is stopped when the information processing apparatus enters the low power consumption state, most of the functions of the information processing apparatus cannot be utilized, impairing usability for the user. Under the circumstances, a technique has been proposed by, for example, Japanese Patent Laid-Open No. 2009-104247 (Document 1) in which after power supply to a HDD has been stopped in the low power consumption state, if a need arises for a process (swap-out process) for transferring less-frequently used data to a secondary or subsequent storage device such as the HDD, the HDD is activated to execute the swap-out process.

The above-described technique, however, has the following problems. In order to access a virtual storage region (hereinafter, referred to as a “swap region”), which is a destination into which data is swapped out, of the HDD as an auxiliary storage device, it is necessary to wait for the HDD to spin up, and as a result the information processing apparatus freezes for several seconds to several tens of seconds. It is also necessary to repeatedly turn the HDD on and off each time swap-out occurs, which inhibits a reduction of power consumption.

### SUMMARY OF THE INVENTION

The present invention has been conceived in view of the above described problems, and provides a mechanism with which it is possible to access a swap region without activating a magnetic auxiliary storage device that is in a non-operational state while making it possible to reduce power consumption by stopping power supply to the magnetic auxiliary storage device.

According to one aspect of the present invention, there is provided an information processing apparatus comprises: a first storage unit; a second storage unit whose access speed is slower than that of the first storage unit configured to store data with use of a magnetic disk; and a third storage unit whose access speed is slower than that of the first storage unit configured to store data with use of a semiconductor memory, the information processing apparatus operating in a first mode in which power is supplied to the second storage unit or a second mode in which power is not supplied to the second storage unit but power is supplied to the third storage unit, wherein the information processing apparatus comprises a control unit configured to control such that part of a storage region of the second storage unit is used as a virtual storage region for the first storage unit when the information processing apparatus is operating in the first mode, and part of a storage region of the third storage unit is used as the virtual storage region for the first storage unit when the information processing apparatus is operating in the second mode.

According to another aspect of the present invention, there is provided a method for controlling an information processing apparatus including a first storage unit, a second storage unit whose access speed is slower than that of the first storage unit configured to store data with use of a magnetic disk, and a third storage unit whose access speed is slower than that of the first storage unit configured to store data with use of a semiconductor memory, the information processing apparatus operating in a first mode in which power is supplied to the second storage unit or a second mode in which power is not supplied to the second storage unit but power is supplied to the third storage unit, the method comprising: controlling such that part of a storage region of the second storage unit is used as a virtual storage region for the first storage unit when the information processing apparatus is operating in the first mode, and part of a storage region of the third storage unit is used as the virtual storage region for the first storage unit when the information processing apparatus is operating in the second mode.

According to another aspect of the present invention, there is provided a storage medium storing a program for causing a computer to function, in an information processing apparatus including a first storage unit, a second storage unit whose access speed is slower than that of the first storage unit configured to store data with use of a magnetic disk, and a third storage unit whose access speed is slower than that of the first storage unit configured to store data with use of a semiconductor memory, the information processing apparatus operating in a first mode in which power is supplied to the second storage unit or a second mode in which power is not supplied to the second storage unit but power is supplied to the third storage unit, as a control unit configured to control such that part of a storage region of the second storage unit is used as a virtual storage region for the first storage unit when the information processing apparatus is operating in the first mode, and part of a storage region of the third storage unit is used as the virtual storage region for the first storage unit when the information processing apparatus is operating in the second mode.

According to the present invention, it is possible to provide a mechanism with which it is possible to access a swap region without activating a magnetic auxiliary storage device that is in a non-operational state while making it possible to reduce power consumption by stopping power supply to the magnetic auxiliary storage device.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram showing a configuration of an image forming apparatus according to Embodiment 1 of the present invention.

FIG. 2 is a diagram showing a processing procedure of the image forming apparatus.

FIG. 3 is a diagram showing a processing procedure of an image forming apparatus according to Embodiment 2.

FIG. 4 is a diagram showing a processing procedure of an image forming apparatus according to Embodiment 3.

### DESCRIPTION OF THE EMBODIMENTS

Hereinafter, embodiments of the present invention will be described in detail with reference to the drawings. It should be understood that the embodiments given below are not intended to limit the scope of the claims of the present invention, and that all combinations of the features described in the embodiments are not necessarily essential to the solving means of the present invention.

### Embodiment 1

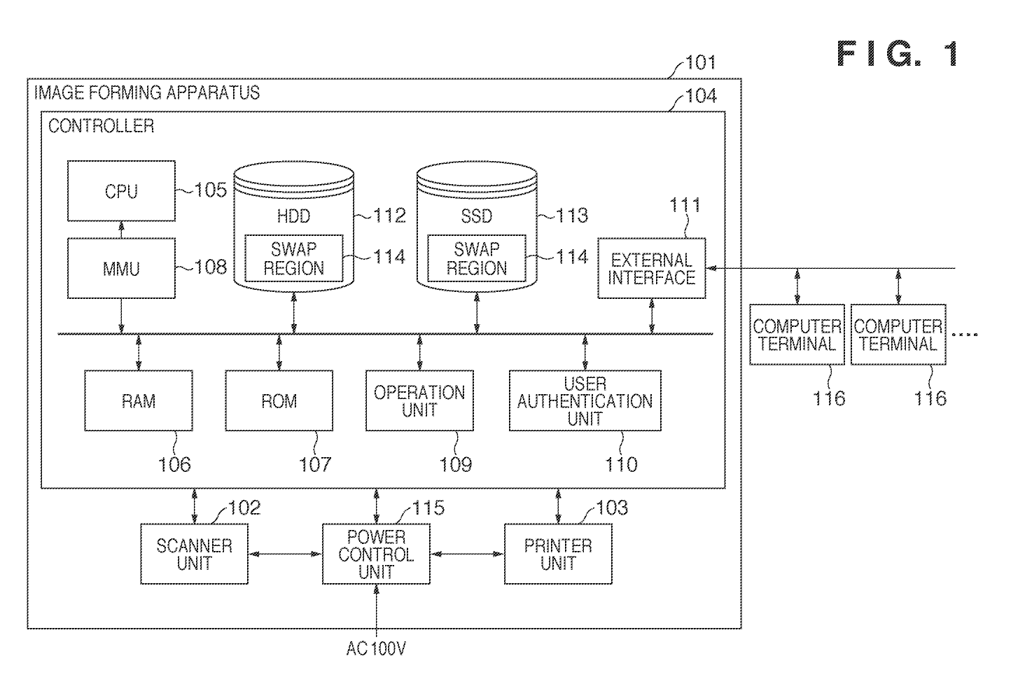

### Configuration of Image Forming Apparatus (FIG. 1)

An image forming apparatus 101 as an information processing apparatus includes a scanner unit 102 that is an image input device, a printer unit 103 that is an image output device, and a controller 104 that controls image processing and processing for forming images. The scanner unit 102 and the printer unit 103 can take various configurations based on known technology, and thus descriptions thereof are omitted here.

The controller 104 includes a CPU 105, a RAM 106, a ROM 107, an MMU 108, an operation unit 109, a user authentication unit 110, an external interface 111, an HDD 112, and an SSD 113.

The CPU 105 performs overall control of the apparatus. The RAM 106 (main storage unit) is a main storage device, such as a DRAM (volatile storage medium), for the CPU 105 to perform operations. The ROM 107 stores, for example, a system boot program and the like.

The MMU 108 (memory management unit) functions as a control unit that performs memory management, and accesses the RAM 106 and the ROM 107 in response to an access from the CPU 105. The MMU 108 also divides physical memory into blocks that are called “pages” or “segments” to manage them, and allocates them to a logical address space. When the physical memory is insufficient, the MMU 108 allocates the HDD 112 and the SSD 113 that are secondary storage devices, which will be described later, to the logical address space. It is thereby possible to provide a virtual memory space (virtual storage region) that is larger than the physical memory for an application running on an OS. The MMU 108 may be built in the CPU 105.

The operation unit 109 is a user interface (UI) for operating the image forming apparatus 101 and displaying the state of the apparatus. The user authentication unit 110 identifies individuals through biometric authentication or the like, and determines whether or not to allow an individual to use the apparatus. The external interface 111 connects the controller 104 to external devices such as computer terminals 116 via a network such as a LAN.

The HDD 112 and the SSD 113 (solid state drive) are secondary storage devices that store an operating system and the like, and that save print jobs and the like received via the external interface 111. The HDD 112 (magnetic auxiliary storage unit) records data on a non-volatile magnetic disk, and the SSD 113 (semiconductor auxiliary storage unit) records data in a non-volatile flash memory. The access speed of the HDD 112 and the SSD 113 is slower than that of the RAM 106. On the other hand, the storage capacity of the HDD 112 and the SSD 113 is larger than that of the RAM 106. And, the access speed of the HDD 112 is slower than that of the SSD 113. On the other hand, the storage capacity of the HDD 112 is larger than that of the SSD 113.

The HDD 112 and the SSD 113 include a swap region 114 (virtual storage region) into which the data stored in the RAM 106 is temporarily transferred when the storage region of the RAM 106 is insufficient. The swap region 114 is partitioned. The swap region 114 is used as a storage destination to which the data stored in the RAM 106, which is a main storage device, is stored when the data is swapped out.

A power control unit 115 generates a direct current power from a commercial power supply (AC 100 V), and supplies the power to the constituent units of the image forming apparatus 101. Also, the power control unit 115 includes a switch capable of turning on and off the direct current power supplied to the constituent units according to an on/off control signal from the controller 104.

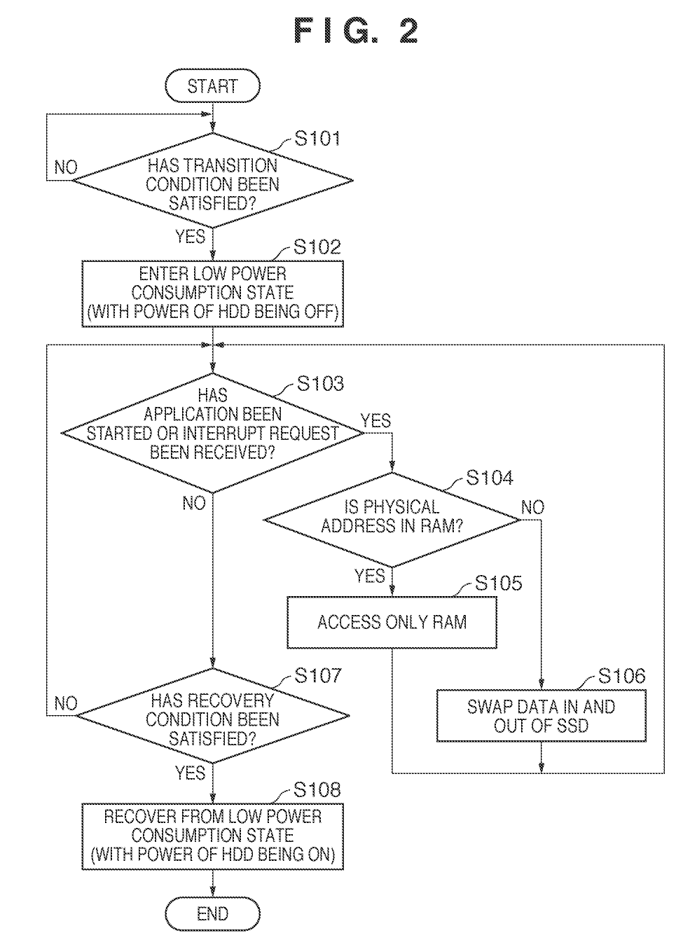

Processing Procedure of Image Forming Apparatus (FIG. 2)

First, the image forming apparatus 101 determines whether or not either of the following transition conditions has been satisfied: whether a predetermined period of time has elapsed in a normal power state; and whether an instruction to transition to a low power consumption state has been received from the operation unit 109 based on a user operation (S101). If neither of the transition conditions has been satisfied, the image forming apparatus 101 waits until either of the transition conditions is satisfied. If, on the other hand, either of the transition conditions has been satisfied, the controller 104 transmits a control signal for turning on/off the constituent units to the power control unit 115. Upon receiving the control signal, the power control unit 115 stops the power supply to the constituent units, and causes the image forming apparatus 101 to enter the low power consumption state (S102).

“Low power consumption state” as used in Embodiment 1 refers to a state in which power is supplied only to the controller 104 excluding the HDD 112, and power is not supplied to the scanner unit 102, the printer unit 103 and the HDD 112. In other words, in the low power consumption state of Embodiment 1, the power of the SSD 113 is on, and the power of the HDD is off.

It is also possible to employ a configuration in which power supply to other units (for example, only the HDD 112 and the printer unit 103) is stopped in the low power consumption state. It is also possible to employ a configuration in which a plurality of low power consumption states having different power consumptions are provided, and power supply to the constituent units is sequentially turned off after a prescribed period of time has elapsed. In this case, the power states that are lower than the normal power state, even if only slightly, are set as low power consumption states.

Next, a determination is made as to whether or not either of the following conditions has been satisfied: whether the image forming apparatus 101 has run an application program during the low power consumption state; and whether various interrupt requests have been received via the external interface 111 during the low power consumption state (S103).

If either of the above conditions has been satisfied, the MMU 108 converts a logical address (virtual address) to a physical address (real address), and determines whether or not the converted physical address is an address in the RAM 106 (S104). If the converted physical address is an address in the RAM 106, the MMU 108 accesses only the RAM 106, and returns to the determination process in S103 (S105). If, on the other hand, the converted physical address is not an address in the RAM 106, the MMU 108 passes control to the OS (operating system) running on the CPU 105, and the OS reads necessary blocks from the swap region 114 of the SSD 113 to the physical memory (swap-in). If the physical memory does not have sufficient empty space to read the blocks, unnecessary blocks are written into the swap region 114 of the SSD 113 (swap-out) (S106). This secures the empty space in the physical memory, and control returns to the MMU 108.

If, on the other hand, neither of the above conditions has been satisfied in S103, the image forming apparatus 101 determines whether or not either of the following recovery conditions has been satisfied: whether the user has submitted a job such as a copy job; and whether an instruction to recover from the low power consumption state to the normal power state has been received from the operation unit 109 based on a user operation (S107). If neither of the recovery conditions has been satisfied, control returns to S103, where the determination process is repeated. If, on the other hand, either of the recovery conditions has been satisfied, the power control unit 115 again starts supplying power to the constituent units (the scanner unit 102, the printer unit 103 and the HDD 112 in Embodiment 1) to which power supply has been stopped, whereby the image forming apparatus 101 recovers from the low power consumption state (S108). When the series of processing until S108 ends, control returns again to S101, where the processing is repeated.

In a storage region other than the swap region 114 of the SSD 113, data that is likely to be requested during operation in the low power consumption state has been stored in advance. In the storage region, for example, application program data that runs in the low power consumption state, authentication information (authentication data) used by the user authentication unit 110 to identify and authenticate individuals, and the like are stored. If authentication information is stored in the HDD 112, the image forming apparatus 101 needs to wait for the HDD 112 to spin up each time an authentication request is received from the user, which makes the authentication time long. For this reason, by storing authentication information in the SSD 113, authentication can be performed instantly. These data may be changed according to various devices connected to the image forming apparatus 101 and application software.

### Embodiment 2

Embodiment 1 above was described in the context of the CPU 105 performing control so as to use only the swap region 114 of the SSD 113 during both the normal power state and the low power consumption state, but Embodiment 2 is different in that the CPU 105 performs control so as to preferentially use the swap region 114 of the HDD 112 during the normal power state, and to use only the swap region 114 of the SSD 113 during the low power consumption state.

This is because there is a limitation on the number of write operations to a flash memory serving as a storage device for the SSD 113 (generally, several tens of thousands of operations to several hundreds of thousands of operations), and thus if the flash memory frequently swaps in and out data, the number of write operations reaches the limit quite early, causing frequent write failures to the SSD 113.

To address this, the priority of use of the swap region 114 of the HDD 112 is set higher than that of the SSD 113 particularly during the normal power state in which access is frequently made, so that the number of occurrences of swap-out to the swap region 114 of the SSD 113 can be reduced as much as possible. This configuration causes the MMU 108 to primarily use the swap region of the HDD 112 during the normal power state, as a result of which the number of overwrite operations to the swap region 114 of the SSD 113 can be suppressed as much as possible, and the service life of the SSD 113 can be prolonged.

The swap region of the HDD 112 has the same size as the swap region 114 of the SSD 113, but the size of the swap region of the HDD 112 may be larger or smaller than that of the swap region of the SSD 113.

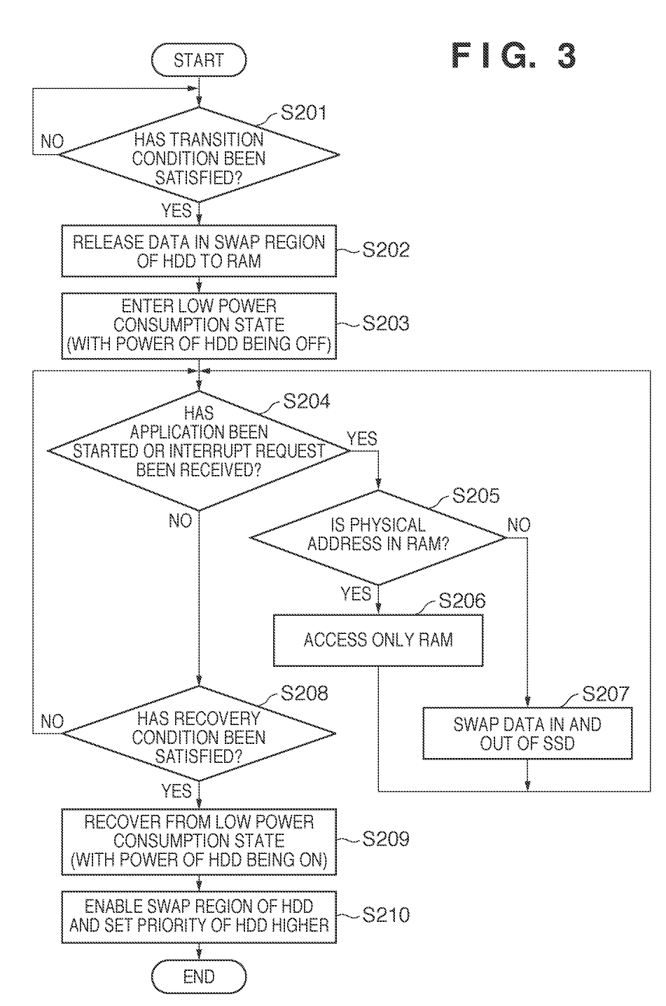

Hereinafter, a processing procedure of an image forming apparatus 101 according to Embodiment 2 will be described with reference to FIG. 3. First, as in Embodiment 1, the image forming apparatus 101 determines whether or not either of the following transition conditions has been satisfied: whether a predetermined period of time has elapsed in the normal power state; and whether a transition instruction to the low power consumption state has been received from the operation unit 109 based on a user operation (S201). If neither of the transition conditions has been satisfied, the image forming apparatus 101 waits until either of the transition conditions is satisfied. If, on the other hand, either of the transition conditions has been satisfied, the CPU 105 releases all of the data in the swap region of the HDD 112 to the RAM 106 (S202), and turns off the swap function of the HDD 112, whereby the image forming apparatus 101 enters the low power consumption state (S203). Steps S204 to S208 are the same as steps S103 to S107 of Embodiment 1 (see FIG. 2), and thus descriptions thereof are omitted here.

Then, if either of the predetermined recovery conditions has been satisfied, the image forming apparatus 101 recovers from the low power consumption state to the normal power state (S209). When power supply to the HDD 112 starts, the CPU 105 enables the swap region of the HDD 112, and sets the priority of use of the swap region of the HDD 112 higher than that of the SSD 113 (S210). Consequently, in the normal power state, the swap region of the HDD 112 is preferentially used, and the swap region of the SSD 113 is used only when the capacity of the swap region of the HDD 112 is insufficient. When the series of processing until S210 ends, control returns again to

S201, where the processing is repeated.

### Embodiment 3

Embodiment 2 was described in the context of the CPU 105 performing control so as to preferentially use the swap region 114 of the HDD 112 during the normal power state and use only the swap region 114 of the SSD 113 during the low power consumption state, but Embodiment 3 is different in that the CPU 105 performs control so as to forcibly use the swap region of the HDD 112 during the normal power state by disabling the swap region of the SSD 113.

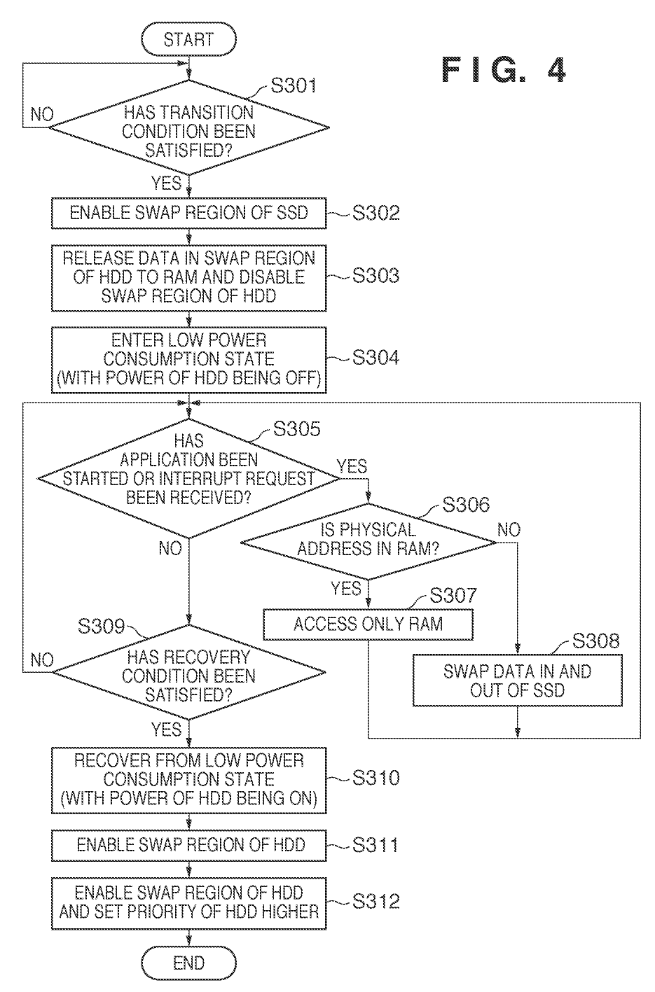

Hereinafter, a processing procedure of an image forming apparatus 101 according to Embodiment 3 will be described with reference to FIG. 4. First, a determination is made as to whether or not either of the following transition conditions has been satisfied: whether a predetermined period of time has elapsed in the normal power state; and whether a transition instruction to the low power consumption state has been received by a user operation (S301). If neither of the transition conditions has been satisfied, the image forming apparatus 101 waits until either of the transition conditions is satisfied. If, on the other hand, either of the transition conditions has been satisfied, the CPU 105 enables the swap region 114 of the SSD 113 (S302). Then, the CPU 105 releases the swap region of the HDD 112, and disables the swap region of the HDD 112 (S303). Steps S304 to S309 are the same as steps S102 to S107 of Embodiment 1 (see FIG. 2), and thus descriptions thereof are omitted here.

Then, if either of the predetermined recovery conditions has been satisfied, the image forming apparatus 101 recovers from the low power consumption state, and turns on the power of the HDD 112 (S310). Then, the CPU 105 enables the swap region 114 of the HDD 112 (S311). After that, the CPU 105 releases the swap region 114 of the SSD 113, and disables the swap region 114 of the SSD 113 (S312). Consequently, in the normal power state, the swap region of the HDD 112 is forcibly used. When the series of processing until S312 ends, control returns again to S301, where the processing is repeated.

In Embodiments 1 to 3 given above, a description was given of a configuration that makes it possible to stop power supply to the HDD 112 by the image forming apparatus 101 using only the swap region of the SSD 113 during the low power consumption state. However, the present invention is not limited to Embodiments 1 to 3, and various modifications can be made within a scope that does not depart from the gist of the present invention, such as using, instead of the SSD 113, another non-volatile semiconductor memory (flash memory) or a volatile memory having a backup function.

According to Embodiments 1 to 3 given above, a swap region is provided in the SSD 113 separately from the HDD 112, and with this configuration, power supply to the HDD 112 can be stopped during the low power consumption state, and it is possible to achieve power saving during the low power consumption state, as well as improved reliability of the HDD 112.

In addition, the configuration in which the priority of use of the swap region of the HDD 112 is set higher than that of the swap region of the SSD 113, or the configuration in which the swap region of the SSD 113 is disabled during the normal power state, is used, and therefore the number of write operations to the SSD 113 can be reduced, and the service life of the SSD 113 can be prolonged.

Embodiments 1 to 3 given above have been described in the context of the information processing apparatus being an image forming apparatus such as a multifunction peripheral, but the information processing apparatus according to the present invention is not limited to an image forming apparatus, and the present invention is applicable to any apparatus as long as it can stop power supply to an auxiliary storage device (HDD) in a low power consumption state.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-248014, filed on Oct. 28, 2009, which is hereby incorporated by reference herein in its entirety.

What is claimed is:

1. An information processing apparatus comprising:
a first storage unit;
a second storage unit whose access speed is slower than that of the first storage unit configured to store data with use of a magnetic disk; and
a third storage unit whose access speed is slower than that of the first storage unit configured to store data with use of a semiconductor memory,
the information processing apparatus operating in a first mode in which power is supplied to the second storage unit or a second mode in which power is not supplied to the second storage unit but power is supplied to the third storage unit,
wherein the information processing apparatus comprises a control unit configured to control such that part of a storage region of the second storage unit is used as a virtual storage region for the first storage unit when the information processing apparatus is operating in the first mode, and part of a storage region of the third storage unit is used as the virtual storage region for the first storage unit when the information processing apparatus is operating in the second mode.

2. The information processing apparatus according to claim 1,
wherein the control unit controls such that data stored in the virtual storage region of the second storage unit is stored in the first storage unit when the information processing apparatus moves from the first mode to the second mode.

3. The information processing apparatus according to claim 1,
wherein data that is used by the information processing apparatus in the second mode is stored in a region different from the virtual storage region of the third storage unit.

4. The information processing apparatus according to claim 1,
wherein power is supplied to the second storage unit and the third storage unit in the first mode.

5. A method for controlling an information processing apparatus including a first storage unit, a second storage unit whose access speed is slower than that of the first storage unit configured to store data with use of a magnetic disk, and a third storage unit whose access speed is slower than that of the first storage unit configured to store data with use of a semiconductor memory, the information processing apparatus operating in a first mode in which power is supplied to the second storage unit or a second mode in which power is not supplied to the second storage unit but power is supplied to the third storage unit, the method comprising:
controlling such that part of a storage region of the second storage unit is used as a virtual storage region for the first storage unit when the information processing apparatus is operating in the first mode, and part of a storage region of the third storage unit is used as the virtual storage region for the first storage unit when the information processing apparatus is operating in the second mode.

6. A storage medium storing a program for causing a computer to function, in an information processing apparatus including a first storage unit, a second storage unit whose access speed is slower than that of the first storage unit configured to store data with use of a magnetic disk, and a third storage unit whose access speed is slower than that of the first storage unit configured to store data with use of a semiconductor memory, the information processing apparatus operating in a first mode in which power is supplied to the second storage unit or a second mode in which power is not supplied to the second storage unit but power is supplied to the third storage unit, as a control unit configured to control such that part of a storage region of the second storage unit is used as a virtual storage region for the first storage unit when the information processing apparatus is operating in the first mode, and part of a storage region of the third storage unit is used as the virtual storage region for the first storage unit when the information processing apparatus is operating in the second mode.
